(19) United States
(12) Patent Application Publication
(10) Pub. No.: US 2018/0229538 A1
(43) Pub. Date: Aug. 16, 2018

(54) Methods and Apparatuses for Pigment Application and Removal

(71) Applicant: Perry Kaye, Cooper City, FL (US)

(72) Inventor: Perry Kaye, Cooper City, FL (US)

(21) Appl. No.: 15/898,227

(22) Filed: Feb. 15, 2018

Related U.S. Application Data
(60) Provisional application No. 62/459,567, filed on Feb. 15, 2017.

(51) Int. Cl. B43K 1/12

(52) U.S. Cl. CPC B43K 1/12

(57) ABSTRACT

A pigment application and removal apparatus, variations, and methods of using. The apparatus or device comprises a housing portion with a reservoir compartment and interfaces for pigment application and for pigment removal. The reservoir compartment houses and supplies pigment to the pigment form interface that is applied to a surface. A person swivels the device in one hand to switch to pigment removal at the pigment removal interface.

### PRIORITY CLAIM

This application claims the benefit of U.S. provisional application No. 62/459,567, filed Feb. 15, 2017, in its entirety.

### FIELD OF THE DISCLOSURE

The present disclosure relates to methods and apparatuses for pigment application and removal. More specifically, the present disclosure presents a single handheld device having multiple interfaces for pigment application and/or removal.

### BACKGROUND OF THE DISCLOSURE

Chalkboards and chalk, dry erase boards and dry erase markers, paper and markers are commonly used for teaching, learning, displaying, advertising, and for simply creating art. Techniques such as writing or drawing with a rounded or chisel tip chalk or marker, highlighting, underlining, striking, outlining, shading in or filling with color, erasing, contrasting, and inverting colors are commonly used to convey a point, expression, or illustration.

Chalkboards are typically a dark color such as black, blue, or green and are written on with a light color chalk such as white, yellow, or pink. The contrast of light color text against a dark background is thought to be easier to read. This is because rooms are typically painted white or a light color and are well lit. Therefore, writing on a white board with a dark color may not always be easy to see.

Dry erase boards, on the other hand, are typically white and written on with dark colors such as black and brown. Dry erase markers are bolder than chalk, so it is typically easier to see than dark chalk on a light background would be.

Classrooms first come to mind, but many businesses such as restaurants use chalkboards and dry erase boards to display specials, menu lists, or other information and graphics. Neon chalk is typically used on a black chalkboard. Visibility is also limited, so sometimes, people have completely covered the chalkboard surface with chalk pigment and then separately erase with a finger or by using multiple tools that frequently become lost. The erased part shows black. Black text against the lighter or neon chalk color may be more visible in darker settings.

One invention that has helped overcome lack of visibility, especially in dark locations, is the electronically illuminated erasable writing board that may have a glass board surface. These have been used as menu signs at restaurants. Although visibility is increased, the expense of the board and the weight of the board are also increased. Even still, if someone wanted to invert text or an image against a neon or colored board surface, multiple tools such as at least one marker and at least one tiny compatible eraser would need to be used. Cotton swabs and fingertips are commonly used in this instance to erase a colored background and become messy.

The other problem is completely and evenly coloring the background. This is a tedious and time consuming task that can quickly use up the pigment in a marker. Chalk can be turned sideways and swiped along the board surface, but the deposited pigment is not as bold as if the chalk point or tip were used.

### SUMMARY OF THE DISCLOSURE

What is needed are methods and apparatuses for pigment application and removal. The apparatus or device for pigment application and removal comprises a housing that may be made of one or multiple portions, at least one pigment form interface, a pigment removal interface, a reservoir, pigment, applicators, facets, and contours. The device may be in a hand grip configuration or in a linear configuration. The device is used by applying one end with the pigment form interface to a surface to apply color. The device is then swiveled by the hand at the contours to switch to a second end with a pigment removal interface. Pigment can be applied and removed from a surface without removing the device from the hand.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure.

FIG. 1 shows an exploded view of an exemplary apparatus for pigment application and removal.

FIG. 2 shows a side sectional view of an exemplary apparatus for pigment application and removal.

FIG. 3 shows a side view of an exemplary apparatus for pigment application and removal.

FIG. 4 shows an exploded view of an exemplary apparatus for pigment application and removal.

FIG. 5 shows a perspective view of an exemplary apparatus for pigment application and removal.

### REFERENCE NUMERALS OF THE DRAWINGS

The following list refers to the drawings to be completed in non-provisional application.
1 Device
3 Proximal end
5 Distal end
7 Cap
9 Housing portion
11 Pigment form interface
13 Housing facet
15 Pigment removal interface
17 Reservoir compartment
19 Tip
21 Contour
23 Grip portion
25 Pigment
27 Reservoir
29 Pigment form
31 Tip applicator
33 Edge

### DETAILED DESCRIPTION

The present disclosure provides generally for methods and apparatuses for material cutting. According to the present disclosure, a device generally comprises at least one housing portion, at least one pigment form interface, at least one pigment removal interface, at least one contour, at least one grip portion, at least one tip, at least one tip applicator, at least one pigment form interface, at least one pigment form, at least one reservoir, and pigment.

In the following sections, detailed descriptions of examples and methods of the disclosure will be given. The description of both preferred and alternative examples are exemplary only, and it is understood that to those skilled in the art that variations, modifications, and alterations may be apparent. It is therefore to be understood that the examples do not limit the broadness of the aspects of the underlying disclosure as defined by the claims.

### Glossary

“pigment” as used herein means any dye, pigment, polish, gel, glitter, graphite, wax, paint, ink, color, or invisible ink.

“pigment form” as used herein means the form in which the pigment is presented and includes, but is not limited to chalk, felt-tip, rollerball, quill, cartridge, and rubber tip.

“reservoir” as used herein means any container for holding pigment.

“pigment form interface” as used herein means any module such as a tip or applicator that allows the transfer of pigment from a reservoir and to a surface.

“a pigment removal interface” as used herein means any apparatus such as a felt, fuzz, rubber, synthetic, natural, wet, or dry eraser capable of removing pigment.

“device” as used herein means the apparatus for pigment application and removal.

“grip portion” as used herein means a portion of a housing ergonomically designed or designated for grabbing by a person. The grip portion may be depressed, textured and/or raised.

### DETAILED DESCRIPTIONS OF THE DRAWINGS

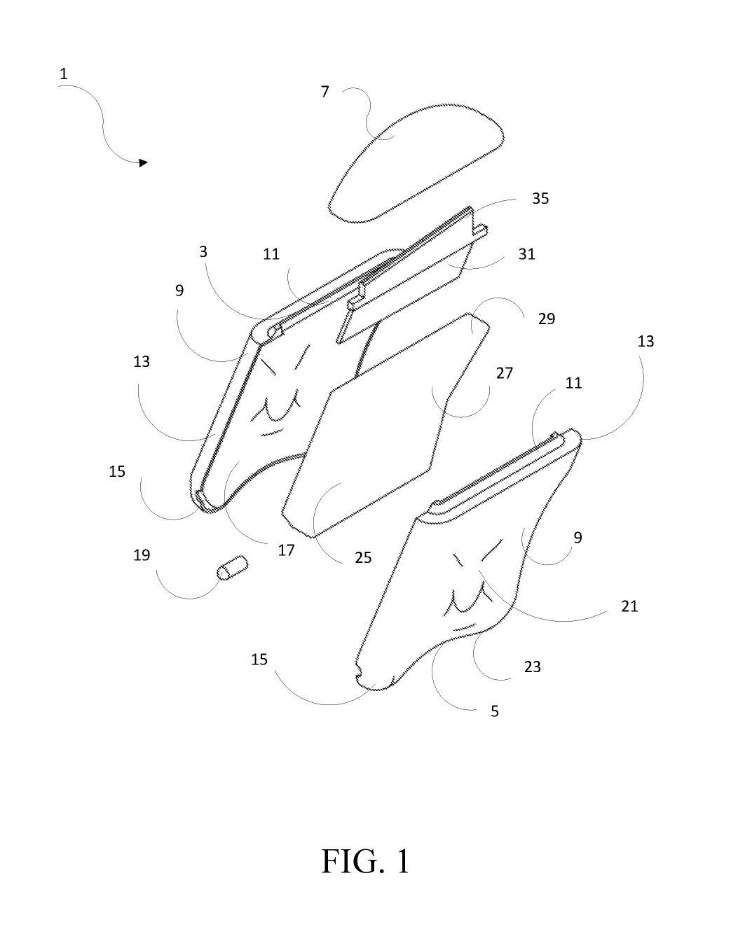

Referring to FIG. 1, an exploded view of an exemplary apparatus for pigment application and removal is shown. The device 1 is depicted in a hand grip configuration and having two housing portions 9, housing facets 13, a pigment form interface 11, a cap 7 at the proximal end 3, a tip applicator 31, a pigment form 29, a reservoir 27 with pigment 25, a contour 21 on the housing portion 9 at the grip portion 23, a distal end, a pigment removal interface, a tip, and a reservoir compartment 17. In addition, some embodiments comprise multiple pigment form interfaces 11 and pigment forms 29.

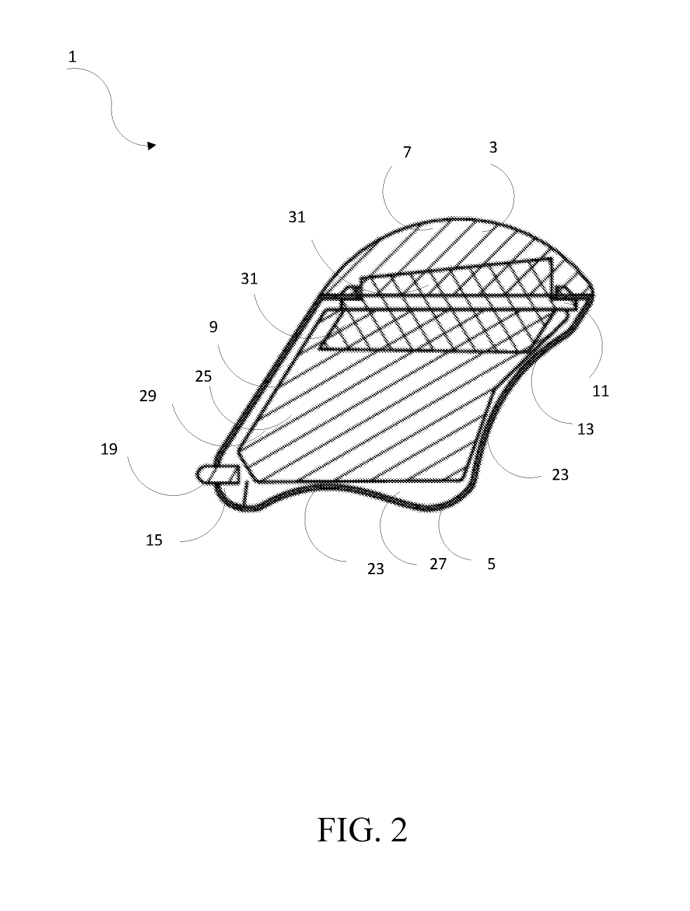

Referring to FIG. 2, a side sectional view of an exemplary apparatus for pigment application and removal is shown. The device 1, like that of the exploded view of FIG. 1, shows a cap 7 at the proximal end, a tip applicator 31, housing facets 13, a pigment form interface 11, grip portions 23 that are perpendicular to each other at the distal end 5, a pigment removal interface 15 with a tip 19 diagonal or opposite of the pigment form interface 11 and edge 35. Inside the device 1 is a pigment form 29, pigment 25, and a reservoir 27 within a housing portion 9.

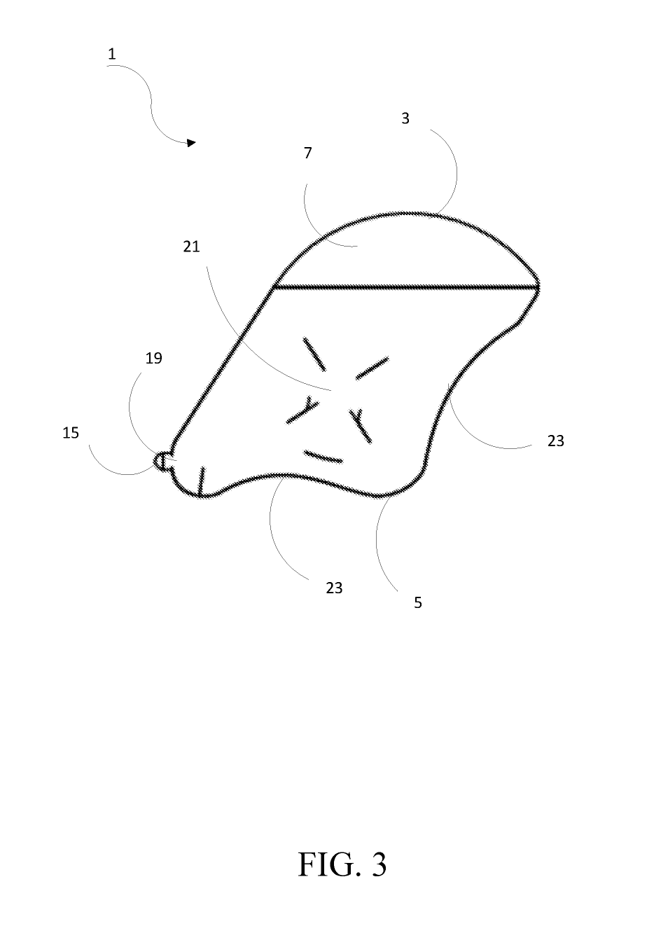

Referring to FIG. 3, a side view of an exemplary apparatus for pigment application and removal is shown. The device 1, like that of FIGS. 1 and 2 shows the exterior of a hand grip configuration. The device 1 is shown with a cap 7 at the proximal end 3, grip portions 23 near the distal end 5, contours 21 for grip and swivel, an exposed pigment removal interface 15 with a tip 19 to facilitate pigment removal.

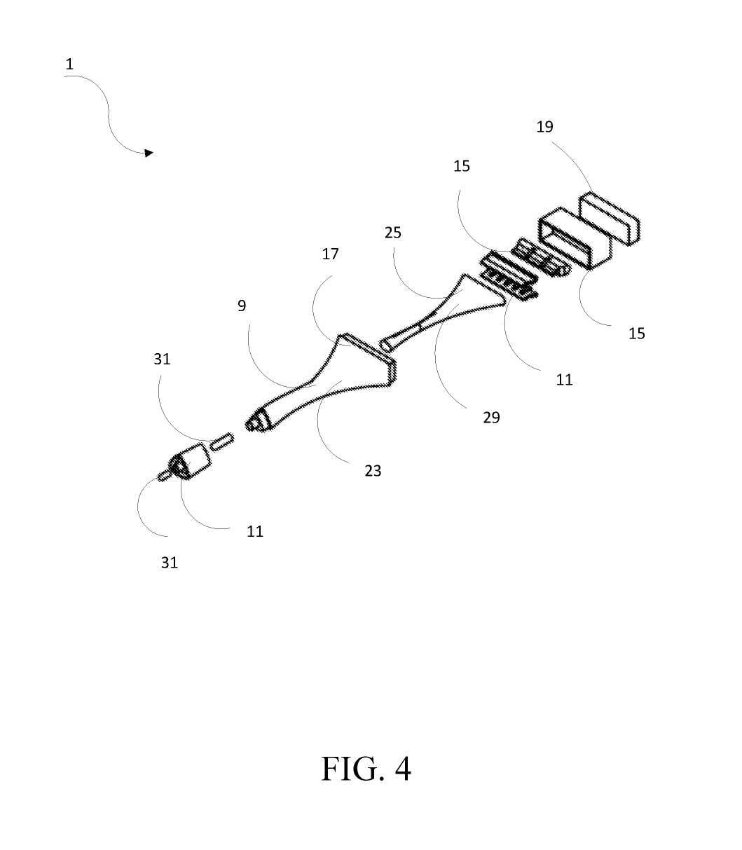

Referring to FIG. 4, an exploded view of an exemplary apparatus for pigment application and removal is shown. The device 1 is shown in a linear configuration. The device 1 comprises a tip applicator 31, a pigment form interface 11, grip portion 23, housing portion 9 with a reservoir compartment 17, pigment 25, a reservoir 27, as well as the opposite end having a at least one pigment removal interface 15 with a pigment form interface 11 or only a pigment form interface 11, and a tip 19 or a tip applicator 31 in an alternative configuration.

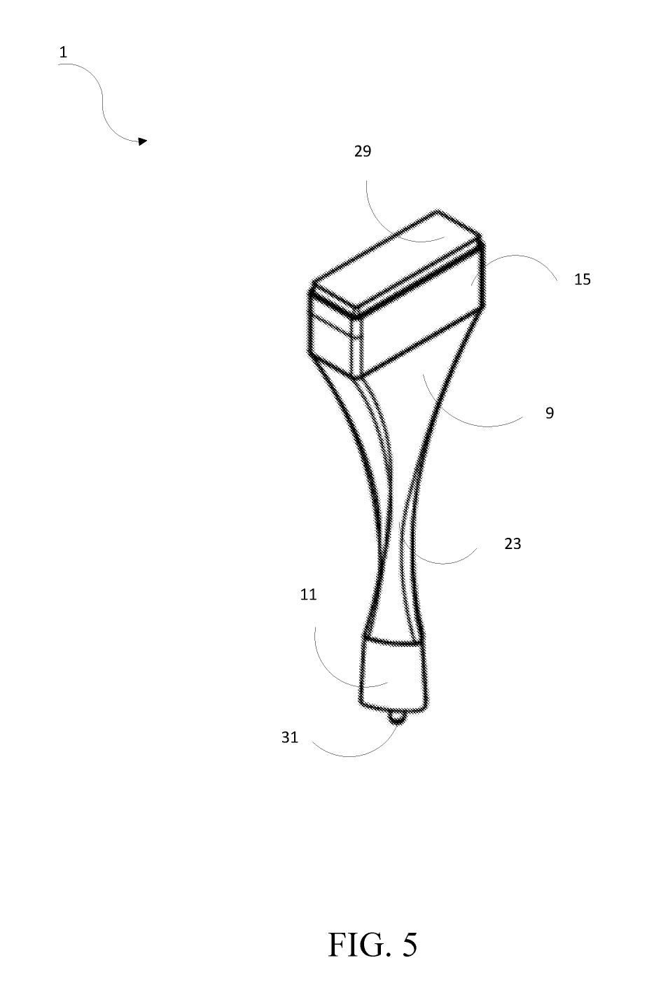

Referring to FIG. 5, a perspective view of an exemplary apparatus for pigment application and removal is shown. Like that of FIG. 4, the device 1 is shown in a linear configuration having a tip applicator 31 with a pigment form interface 11, a grip portion 23 at the housing portion 9, and at the opposite end a pigment removal interface 15 with tip 19 or pigment form 29 in an alternative configuration.

Exemplary embodiments of a device allow for a person to use a single device to apply pigment to a large area, apply pigment in small areas or for text, and to remove pigment. In some embodiments, a housing portion may be comprised of multiple detached housing portions that frictionally snap or fit into the remainder of or complementary to another housing portion. Some housing portions may comprise two pigment forms. The pigment forms in this exemplary embodiment are felt and extend both into the reservoir to grab pigment and out to a pigment form interface that is applied to a surface to deposit pigment to that surface.

A housing may comprise of one single parts or of multiple detachable parts. When a detached housing portion is opened, a reservoir is revealed in the cavity of the housing. The reservoir contains pigment. A reservoir may be refillable and may have several compartments or may be segmented.

A person grips the device. The device may be contoured. When a person wants to switch from applying pigment to removing pigment, the person swivels the device so that a facet having pigment form interfaces touching a surface is swung away from the surface while swinging the housing facet having the pigment removal interface close to the surface. The person then applies the pigment removal interface to the surface to remove pigment that was previously applied to the surface. Pigment application and removal is thus accomplished with a single device without needing to remove the device from a person's hand. Devices may be modular, have some parts fixedly combined as a single assembly, or may be completely fixedly combined into a single assembly.

In some embodiments, a device may comprise two pigment form interfaces, each with a tip applicator. The tip applicator may be linear, polygonal, or may have a tip that is rounded, pointed, or chiseled.

A device may have a cap for covering pigment forms and pigment form interfaces. The device housing may have one or more housing facets. Each housing facet may have one or more pigment form interfaces and/or pigment removal interfaces. In some embodiments, the pigment form interface is on a facet that may be perpendicular to or on a facet adjacent to the housing facet that has at least one pigment removal interface. The housing facets having form interfaces may be linear and may have curved, linear, angled, and/or tapered edges and points. The housing facets having form interfaces may be at the distal end or the proximal of the housing.

A housing may have at least one sigmoid, concave, and/or convex housing facet. These housing facets may have curved, linear, angled, and/or tapered edges. These housing facets may be present at the proximal end or the distal end of the housing.

A device should comfortably fit in the palm of a person's hand. The person's fingers may be placed at the grip portion. The grip portion may be in the center or may be offset on the housing.

In some embodiments, the pigment form is liquid pigment in a felt applicator. The pigment form interfaces may be a rectangular felt tip applicator and a round-point felt tip. A rectangular felt tip applicator may be between ¼ inch to 4 inches long and may by 1/16 to 2 inches wide. A rectangular felt tip may be used for applying a substantially even coat of pigment to a relatively large surface such as a sidewalk chalkboard or a dry erase board. A round-point felt tip may be of varying circumferences and may be present of an angled housing facet that may be angled away from the rectangular felt tip applicator, so use of either pigment form interface will not interfere with the other.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Thus, particular embodiments of the subject matter have been described. Other embodiments are within the scope of the following claims. In some cases, the actions recited in the claims can be performed in a different order and still achieve desirable results. Nevertheless, it will be understood that various modifications may be made without departing from the spirit and scope of the claimed disclosure.

What is claimed is:

1. A device for pigment application and removal, the device comprising
a housing,
a pigment form interface with a tip applicator,
a pigment removal interface with a tip,
a reservoir compartment with a reservoir,
pigment,
a grip portion, and
a contour.

2. The device of claim 1 further comprising a cap.

3. The device of claim 1 further comprising a pigment form.

4. The device of claim 1 further comprising a second tip applicator along an edge of the pigment form interface.

5. The device of claim 1 wherein the device is in a hand grip configuration.

6. The device of claim 1 wherein the device is in a linear configuration.

7. The device of claim 5 wherein the housing portion contains a contour indentation for indicating swivel points for the thumb and fingers.

8. The device of claim 6 wherein the grip portion is tapered for indicating swivel points for the thumb and fingers.

9. A method for applying and subsequently removing pigment with a device comprising a housing having facets, contours, and grip portions, with a pigment-filled reservoir, a pigment form interface with a tip applicator, and a pigment removal interface with a tip, the method steps comprising:
grabbing the device so that grip portions on housing facets saddle the palm of the hand;
placing thumb and fingers at contours;
removing a cap;
pressing the pigment form interface with tip applicator on a surface to release pigment from the reservoir and onto the surface;
lifting the device tip applicator from the surface;
swiveling the device in the hand so that the tip is facing the surface;
pressing the tip to the surface with deposited pigment;
sliding the tip along the pigmented surface to facilitate removal of pigment.

10. The method of claim 9 whereby the device is grabbed with a proximal end facing upward and a distal end facing downward.

11. The method of claim 9 further comprising the step of removing a cap to reveal the pigment form interface and tip applicator.

12. The method of claim 10 further comprising swiveling the device so that the proximal end faces downward and the distal end faces upward.
